(19) United States
(12) Patent Application Publication
(10) Pub. No.: US 2006/0132947 A1
(43) Pub. Date: Jun. 22, 2006

(54) Color wheel and motor thereof

(75) Inventors: Kuang-Hua Chang, Junghe City (TW); Chih-Huang Wang, Taipei County (TW); Ke-Shu Chin, Taipei County (TW); Nai-Yueh Liang, Taipei City (TW); Chong-Han Tsai, Taipei County (TW)

Correspondence Address: BIRCH STEWART KOLASCH & BIRCH, PO BOX 747, FALLS CHURCH, VA, 22040-0747, US

(73) Assignee: Prodisc Technology Inc.

(21) Appl. No.: 11/075,946

(22) Filed: Mar. 10, 2005

(30) Foreign Application Priority Data
Dec. 21, 2004 (TW) 093139902

(51) Int. Cl. G02B 7/00

(52) U.S. Cl. 359/892; 359/891

(57) ABSTRACT

A color wheel includes a color filter and a motor. In this case, the motor has an shaft, a rotor-oriented element, and a motor shell. The shaft is vertically installed on the rotor-oriented element. The motor shell has an opening in a direction of the shaft. The rotor-oriented element and the shaft are set inside the motor shell. The rotor-oriented element covers the opening of the motor shell, so as to form a concave portion constructed by the motor shell and the rotor-oriented element. The color filter is set on a surface of the motor, which is formed with the concave portion.

### BACKGROUND OF THE INVENTION

1. Field of Invention

The invention relates to a color wheel and a motor thereof and, in particular, to a color wheel and a motor thereof, which are used in a projection system.

2. Related Art

The popular projection systems are divided into three types including a liquid crystal display (LCD) type, a liquid crystal on silicon (LCoS) type, and a digital light processing (DLP) type. Herein, the DLP projector has the advantages of high brightness, correct colour reproduction, fast response time, no noise, light and compact, so it has become one of the most popular projection technologies.

In a DLP projector, a digital control method and a reflection principle are adopted. First, light beams are collimated, integrated by a lens and then pass through a color filter of a color wheel. The light beams are then projected onto a digital micro-mirror device (DMD). Since the DMD includes several movable micro-mirrors, driving electrodes may control the tilt angle and deflection time of each movable mirror. Then, the light beams may be projected to form an image by switching the reflection directions of the light beams.

With reference to FIG. 1, a conventional color wheel 1 includes a motor 11, a color filter 12 and a cap 13. The motor 11 is mainly composed of a motor shell 111, a shaft housing 112, a fixing plate 113 and a coil 114. The color filter 12 is firstly attached to the ring-shaped cap 13, and then the cap 13 is disposed on the shaft housing 112 of the motor 11. In this case, the center hole of the cap 13 is aligned to a protrusion of the shaft housing 112, and the ring-shaped cap 13 is adhered to a ring-shaped surface of the shaft housing 112. Herein, the color filter 12 is usually a ring-shaped glass with several coating layers of desired color; otherwise, it can be composed of several fan-shaped glasses with coating layers. Thus, when the motor 11 is operated, the cap 13 and color filter 12 can be driven to rotate.

Referring to FIG. 2, regarding to the conventional design, a shaft 1131 is mounted on the fixing plate 113, and a bearing 1121 is installed inside the shaft housing 112. When the coil 114 of the motor 11 is electrified, the magnetic field inside the motor 11 is changed in sequence to generate a rotation magnetic field, which causes the rotation of the motor shell 111 and the shaft housing 112 of the motor 11.

To make the projection system present perfect color, the color wheel must rotate in a very high speed such as over 7200 rpm. Therefore, the reliability and dynamic balance between the assemblies of the motor or color wheel are very critical. For example, if the unbalance phenomenon occurs in the high-speed rotating motor or the color wheel, the color filter may be swung away and the color wheel may have vibration, noise, improper friction, and abrasion, which result in the shortened lifetime of the color wheel and motor. However, the conventional motor shell is a sleeve, and the shaft housing is necessary to present a planar surface for disposing the color filter and the cap. This structure does not provide any design for correcting the dynamic balance of the motor or color wheel. It is therefore an important subjective of the invention to provide a motor and a color wheel, which have a simple structure and can perform dynamic balance correction.

### SUMMARY OF THE INVENTION

In view of the foregoing, the invention is to provide a motor, which can perform dynamic balance correction.

In addition, the invention is to provide a color wheel, which has a simple structure and can perform dynamic balance correction.

To achieve the above, a motor of the invention includes a shaft, a rotor-oriented element, and a motor shell. In the invention, the shaft is vertically installed on the rotor-oriented element. The motor shell has an opening in a direction of the shaft. The rotor-oriented element and the shaft are disposed inside the motor shell. The rotor-oriented element covers the opening, so that the motor shell and the rotor-oriented element form a concave portion.

To achieve the above, a color wheel of the invention includes a color filter and a motor. In the invention, the motor includes a shaft, a rotor-oriented element, and a motor shell. The shaft is vertically installed on the rotor-oriented element. The motor shell has an opening in a direction of the shaft. The rotor-oriented element and the shaft are disposed inside the motor shell. The rotor-oriented element covers the opening, so that the motor shell and the rotor-oriented element form a concave portion. The color filter is disposed on a surface of the motor formed with the concave portion.

To achieve the above, the invention also provides a color wheel that includes a color filter and a motor. In this case, the motor includes a shaft and a motor shell, which has a concave portion in a direction of the shaft. The concave portion has a bottom surface perpendicular to the direction of the shaft, and the shaft is vertically installed on one side of the bottom surface facing to the internal of the motor shell. The color filter is disposed on a surface of the motor formed with the concave portion.

As mentioned above, the color wheel and motor of the invention have an opening, which is covered with the rotor-oriented element. Thus, a concave portion can be formed by the motor shell and the rotor-oriented element, and can be used for performing dynamic balance correction as the motor rotates. Furthermore, since the color wheel and motor of the invention have a concave portion for performing dynamic balance correction, an additional heavy object can be disposed in the concave portion to make the unbalance color wheel or motor to reach balance. Thus, the conventional problems that the color filter may be swung away and the color wheel may have vibration, noise, improper friction and abrasion can be improved. Accordingly, the color wheel and motor of the invention may rotate more smooth, and have longer lifetime.

### BRIEF DESCRIPTION OF THE DRAWINGS

The invention will become more fully understood from the detailed description given herein below illustration only, and thus is not limitative of the present invention, and wherein:

FIG. 1 is a schematic sectional view showing the conventional color wheel;

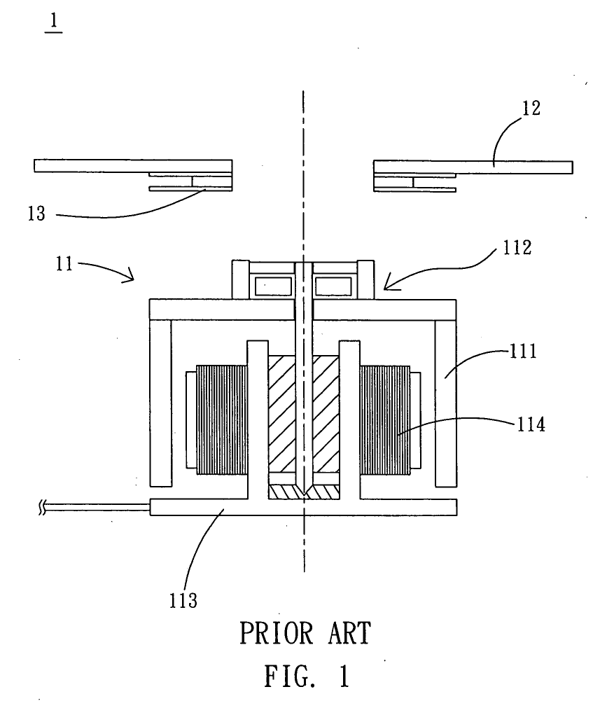

FIG. 2 is a schematic sectional view showing the conventional motor of the color wheel;

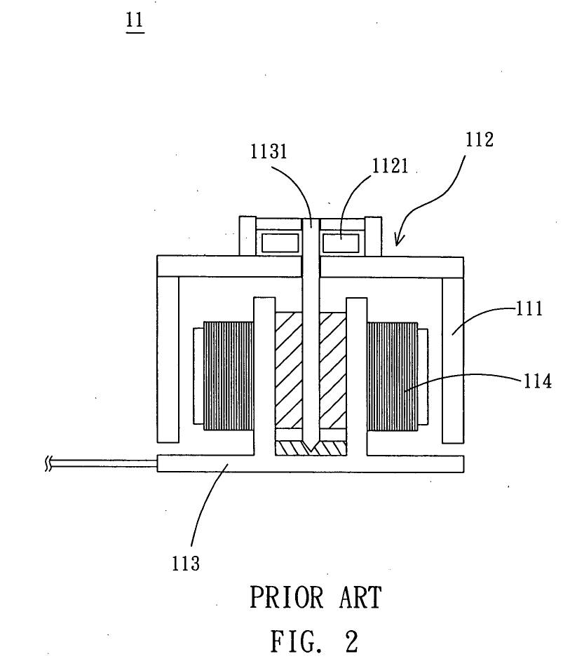

FIG. 3 is a schematic sectional view showing a motor according to a preferred embodiment of the invention;

FIG. 4 is a schematic sectional view showing a motor according to another preferred embodiment of the invention;

FIG. 5 is a schematic sectional view showing a color wheel according to a preferred embodiment of the invention;

FIG. 6 is a schematic sectional view showing another color wheel according to the preferred embodiment of the invention;

FIG. 7 is a schematic sectional view showing a color wheel according to another preferred embodiment of the invention;

FIG. 8 is a schematic sectional view showing another color wheel according to another preferred embodiment of the invention;

FIG. 9 is a schematic sectional view showing a color wheel according to yet another preferred embodiment of the invention; and

FIG. 10 is a schematic sectional view showing another color wheel according to yet another preferred embodiment of the invention.

### DETAILED DESCRIPTION OF THE INVENTION

The present invention will be apparent from the following detailed description, which proceeds with reference to the accompanying drawings, wherein the same references relate to the same elements.

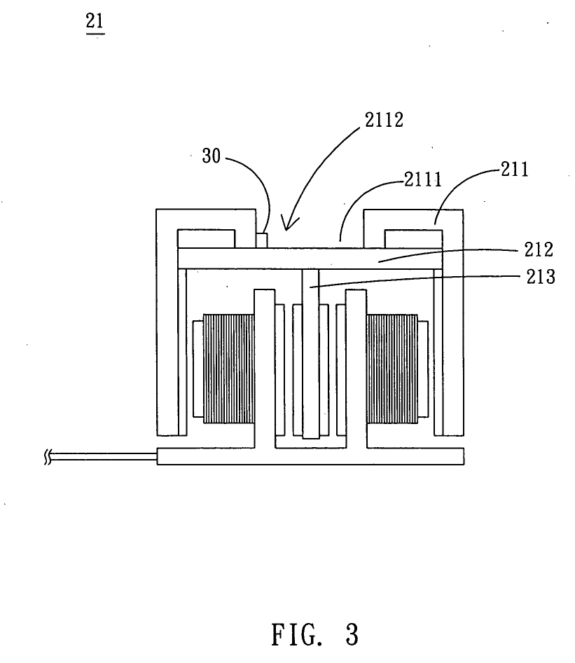

With reference to FIG. 3, a motor 21 according to a preferred embodimetn of the invention includes a motor shell 211, a rotor-oriented element 212 and a shaft 213. The shaft 213 is vertically installed on the rotor-oriented element 212. The motor shell 211 has an opening 2111 in a direction of the shaft 213. The rotor-oriented element 212 and the shaft 213 are disposed inside the motor shell 211. The rotor-oriented element 212 covers the opening 2111, so that the motor shell 211 and the rotor-oriented element 212 form a concave portion 2112. When the motor 21 is electrified, the magnetic field inside the motor 21 is changed in sequence to generate a rotation magnetic field, which causes the rotation of the shaft 213 and the rotor-oriented element 212 so as to drive the motor shell 211 to rotate. In addition, if the unbalance phenomenon occurs during the motor 21 is in a balance testing, a heavy object 30 can be disposed in the concave portion 2112 for performing balance correction. In the present embodiment, the rotor-oriented element 212 and the motor shell 211 are tightly wedged to each other. Of course, they can be adhered to each other or riveted to each other.

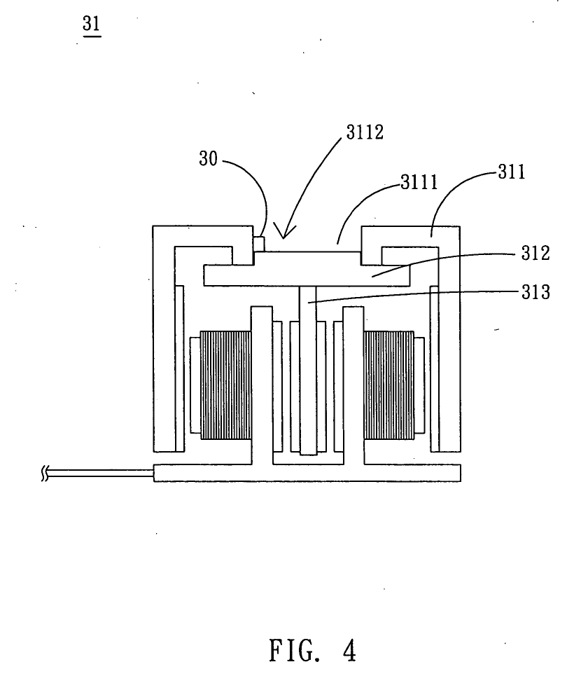

With reference to FIG. 4, a motor 31 according to another preferred embodiment of the invention includes a motor shell 311, a rotor-oriented element 312 and a shaft 313. The shaft 313 is vertically installed on the rotor-oriented element 312. The motor shell 311 has an opening 3111 in a direction of the shaft 313. The rotor-oriented element 312 and the shaft 313 are disposed inside the motor shell 311. The rotor-oriented element 312 covers the opening 3111, so that the motor shell 311 and the rotor-oriented element 312 form a concave portion 3112. When the motor 31 is electrified, the magnetic field inside the motor 31 is changed in sequence to generate a rotation magnetic field, which causes the rotation of the shaft 313 and the rotor-oriented element 312 so as to drive the motor shell 311 to rotate. In addition, if the unbalance phenomenon occurs during the motor 31 is in a balance testing, a heavy object 30 can be disposed in the concave portion 3112 for performing balance correction.

In the current embodiment, the rotor-oriented element 312 is a little different from the rotor-oriented element 212 of the previous embodiment (as shown in FIG. 3) in shape. Thus, when the rotor-oriented element 312 is positioned inside the motor shell 311, the configuration of the embodiment differs from that of the previous embodiment. In this embodiment, the rotor-oriented element 312 and the motor shell 311 are tightly wedged to each other. Of course, depending on the user's demands and manufacturing requirements, they can be adhered to each other or riveted to each other.

The color wheel of the invention will be apparent from the following detailed description, wherein the references of the following embodiments are the same as those relate to the same elements described in the previously mentioned embodiment.

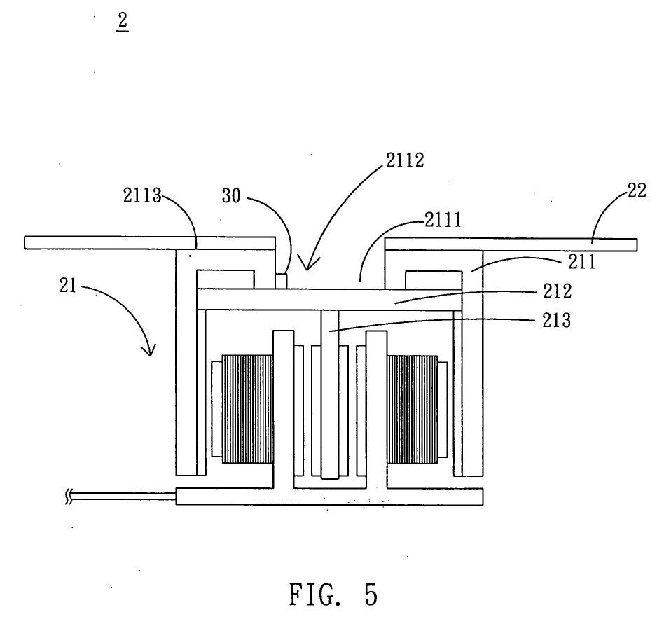

With reference to FIG. 5, the motor of this embodiment relates to the same references as previous embodiment.

A color wheel 2 according to a preferred embodimetn of the invention inlcudes a motor 21 and a color filter 22. The motor 21 includes a motor shell 211, a rotor-oriented element 212 and a shaft 213. The shaft 213 is vertically installed on the rotor-oriented element 212. The motor shell 211 has an opening 2111 in a direction of the shaft 213. The rotor-oriented element 212 and the shaft 213 are disposed inside the motor shell 211. The rotor-oriented element 212 covers the opening 2111, so that the motor shell 211 and the rotor-oriented element 212 form a concave portion 2112. The color filter 22 is disposed on a surface 2113 of the motor 21 formed with the concave portion 2112. In this case, the color filter 22 and the rotor-oriented element 212 are configured in parallel. When the motor 21 is electrified, the shaft 213 and the rotor-oriented element 212 are rotated so as to drive the motor shell 211 and the color filter 22 to rotate. If the unbalance phenomenon occurs during the color wheel 2 is in a balance testing, a heavy object 30 can be disposed in the concave portion 2112 for performing balance correction.

In the present embodiment, the rotor-oriented element 212 and the motor shell 211 are tightly wedged to each other. Of course, they can be adhered to each other or riveted to each other. The color filter 22 of the embodiment is a ring-shaped color filter, which is a ring-shaped transparent substrate with several coating layers including sectors of red, green and blue, or red, green, blue and white. Certainly, it can be composed of several pieces of fan-shaped glass with several coating layers. The dimension of the central hole of the ring-shaped color filter can be adjusted based on actual requirements.

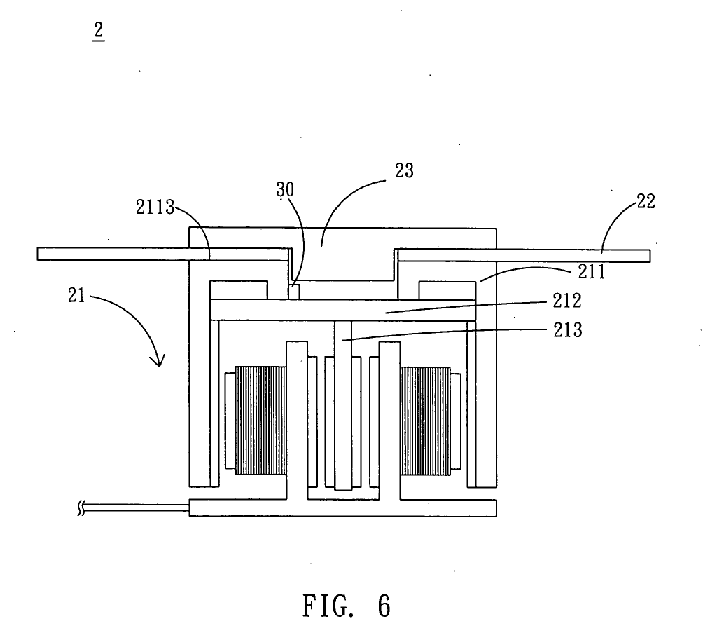

As shown in FIG. 6, the color wheel 2 of the embodiment may further include a cap 23, which is disposed on the color filter 22. The color filter 22 is positioned between the cap 23 and the motor 21. According to the cap 23, the color filter 22 and the motor 21 may combine to each other more tightly. The cap 23 also can be a fixing reference when disposing the color filter 22 on the surface 2113 of the motor 21.

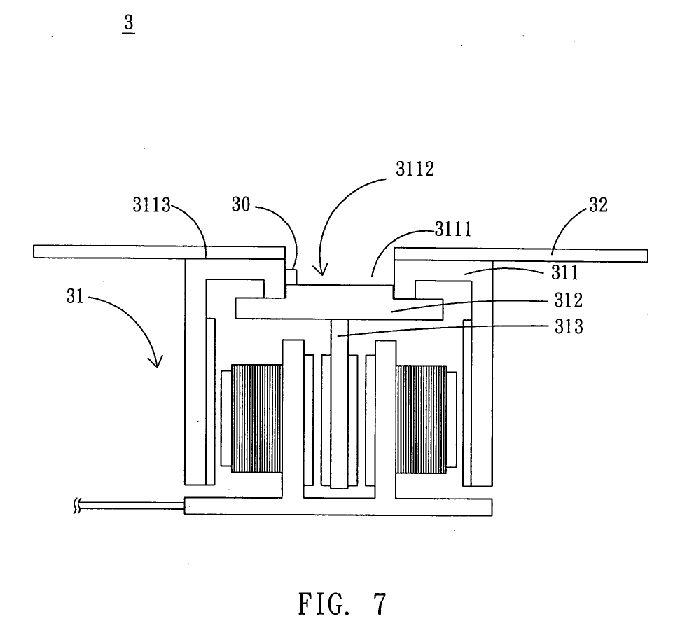

With reference to FIG. 7, a color wheel 3 according to another embodiment of the invention includes a motor 31 and a color filter 32. The motor 31 includes a motor shell 311, a rotor-oriented element 312 and a shaft 313. The shaft 313 is vertically installed on the rotor-oriented element 312. The motor shell 311 has an opening 3111 in a direction of the shaft 313. The rotor-oriented element 312 and the shaft 313 are disposed inside the motor shell 311. The rotor-oriented element 312 covers the opening 3111, so that the motor shell 311 and the rotor-oriented element 312 form a concave portion 3112. The color filter 32 is disposed on a surface 3113 of the motor 31 formed with the concave portion 3112. In this case, the color filter 32 and the rotor-oriented element 312 are configured in parallel. When the motor 31 is electrified, the shaft 313 and the rotor-oriented element 312 are rotated so as to drive the motor shell 311 and the color filter 32 to rotate. If the unbalance phenomenon occurs during the color wheel 3 is in a balance testing, a heavy object 30 can be disposed in the concave portion 3112 for performing balance correction.

In the current embodiment, the rotor-oriented element 312 and the motor shell 311 are tightly wedged to each other. Of course, they can be adhered to each other or riveted to each other. The color filter 32 of the embodiment is a ring-shaped color filter, which is a ring-shaped transparent substrate with several coating layers including sectors of red, green and blue, or red, green, blue and white. Certainly, it can be composed of several pieces of fan-shaped glass with several coating layers. The dimension of the central hole of the ring-shaped color filter can be adjusted based on actual requirements.

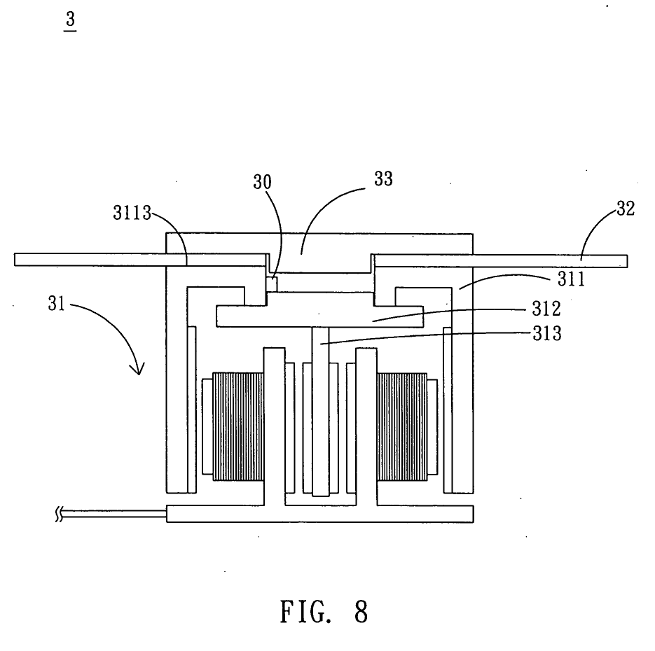

With reference to FIG. 8, the color wheel 3 of the embodiment may further include a cap 33, which is disposed on the color filter 32. The color filter 32 is positioned between the cap 33 and the motor 31. According to the cap 33, the color filter 32 and the motor 31 may combine to each other more tightly. The cap 33 also can be a fixing reference when disposing the color filter 32 on the surface 3113 of the motor 31.

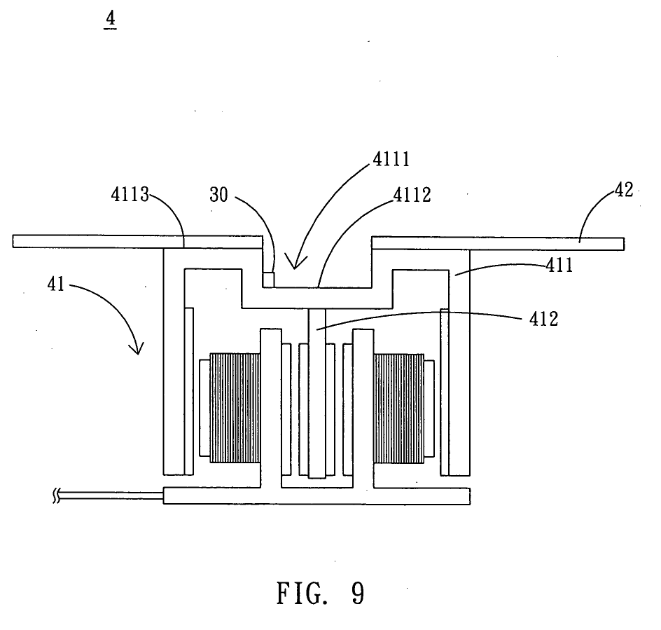

With reference to FIG. 9, a color wheel 4 according to yet another embodiment of the invention includes a motor 41 and a color filter 42. The motor 41 includes a motor shell 411 and a shaft 412. The motor shell 411 is integrally formed and has a concave portion 4111 in a direction of the shaft 412. The concave portion 4111 has a bottom surface 4112 perpendicular to the direction of the shaft 412. The shaft 412 is vertically installed on one side of the bottom surface 4112 facing to the internal of the motor shell 411. The color filter 42 is disposed on a surface 4113 of the motor 411 formed with the concave portion 4111. When the motor 41 is electrified, the shaft 412 is rotated so as to drive the motor shell 411 and the color filter 42 to rotate. If the unbalance phenomenon occurs during the color wheel 4 is in a balance testing, a heavy object 30 can be disposed in the concave portion 4111 for performing balance correction.

In this embodiment, the color filter 42 is a ring-shaped color filter, which is a ring-shaped transparent substrate with several coating layers including sectors of red, green and blue, or red, green, blue and white. Certainly, it can be composed of several pieces of fan-shaped glass with several coating layers. The dimension of the central hole of the ring-shaped color filter can be adjusted based on actual requirements.

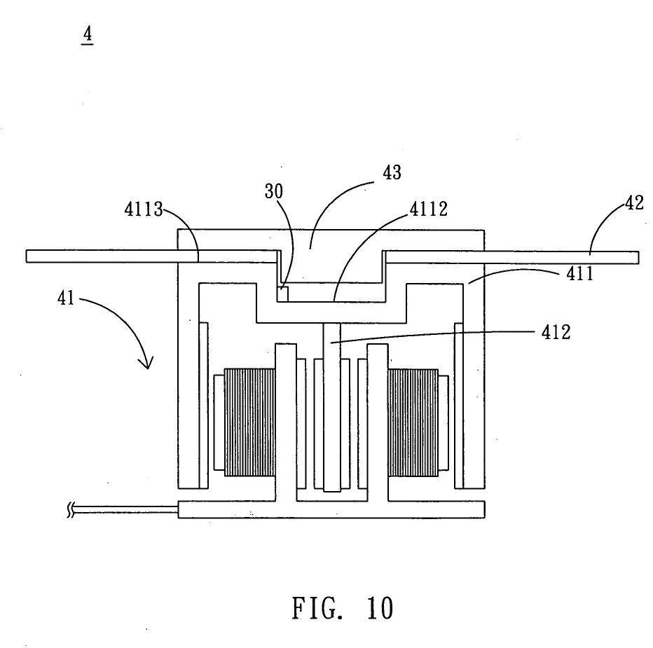

As shown in FIG. 10, the color wheel 4 of the current embodiment may further include a cap 43, which is disposed on the color filter 42. The color filter 42 is positioned between the cap 43 and the motor 41. According to the cap 43, the color filter 42 and the motor 41 may combine to each other more tightly. The cap 43 also can be a fixing reference when disposing the color filter 42 on the surface 4113 of the motor 41.

As mentioned above, the color wheel and motor of the invention have an opening, which is covered with the rotor-oriented element. Thus, a concave portion can be formed by the motor shell and the rotor-oriented element, and can be used for performing dynamic balance correction as the motor rotates. Furthermore, an additional heavy object can be disposed in the concave portion to make the unbalance color wheel or motor to reach balance. Thus, the conventional problems that the color filter may be swung away and the color wheel may have vibration, noise, improper friction and abrasion can be improved. Accordingly, the color wheel and motor of the invention may rotate more smooth, and have longer lifetime. Comparing with the prior art, the color wheel and motor of the invention do not comprise the conventional shaft housing, so that the applicable color filter may have a central hole of variant dimensions without being limited by the protrusion of the conventional shaft housing. In addition, the concave portion of the invention is not only for accommodating the heavy object when performing dynamic balance correction, but also for filling with an adhesive to increase the adhering strength between the color filter and the motor shell, which reduces the chance of released color filter. The concave portion can also receive the redundant adhesive so as to prevent the color filter from being tainted by the overflowed adhesive. The additional cap can make the combination between the color filter and the motor shell stronger, and can help the orientation of the color filter. Therefore, the color filter and motor of the invention provides a more flexible glass assembling method, more spaces for performing the dynamic balance correction, and longer lifetime.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motor, comprising:
a shaft;
a rotor-oriented element, on which the shaft is vertically installed; and
a motor shell, which has an opening in a direction of the shaft, wherein the rotor-oriented element and the shaft are disposed inside the motor shell, the rotor-oriented element covers the opening of the motor shell, and the motor shell and the rotor-oriented element form a concave portion.

2. The motor of claim 1, wherein the rotor-oriented element and the motor shell are tightly wedged to each other.

3. The motor of claim 1, wherein the rotor-oriented element and the motor shell are adhered to each other.

4. The motor of claim 1, wherein the rotor-oriented element and the motor shell are riveted to each other.

5. The motor of claim 1, wherein a heavy object is set in the concave portion.

6. A color wheel, comprising:
a color filter; and
a motor, which comprises a shaft, a rotor-oriented element and a motor shell, wherein the shaft is vertically installed on the rotor-oriented element, the motor shell has an opening in a direction of the shaft, the rotor-oriented element and the shaft are disposed inside the motor shell, the rotor-oriented element covers the opening of the motor shell, the motor shell and the rotor-oriented element form a concave portion, and the color filter is disposed on a surface of the motor formed with the concave portion.

7. The color wheel of claim 6, wherein the rotor-oriented element and the motor shell are tightly wedged to each other.

8. The color wheel of claim 6, wherein the rotor-oriented element and the motor shell are adhered to each other.

9. The color wheel of claim 6, wherein the rotor-oriented element and the motor shell are riveted to each other.

10. The color wheel of claim 6, wherein the color filter is composed of a piece of glass with at least one coating layer.

11. The color wheel of claim 6, wherein the color filter is composed of a plurality of pieces of glass with coating layers.

12. The color wheel of claim 6, wherein the color filter is a ring-shaped color filter:

13. The color wheel of claim 6, further comprising:
a cap, which is disposed on the color filter, wherein the color filter is positioned between the cap and the motor.

14. The color wheel of claim 6, wherein a heavy object is set in the concave portion.

15. A color wheel, comprising:
a color filter; and
a motor, which comprises a shaft and a motor shell, wherein the motor shell has a concave portion in a direction of the shaft, the concave portion has a bottom surface perpendicular to the direction of the shaft, the shaft is vertically installed on one side of the bottom surface facing to the internal of the motor shell, and the color filter is disposed on a surface of the motor formed with the concave portion.

16. The color wheel of claim 15, wherein the color filter is composed of a piece of glass with at least one coating layer.

17. The color wheel of claim 15, wherein the color filter is composed of a plurality of pieces of glass with coating layers.

18. The color wheel of claim 15, wherein the color filter is a ring-shaped color filter.

19. The color wheel of claim 15, further comprising:
a cap, which is disposed on the color filter, wherein the color filter is positioned between the cap and the motor.

20. The color wheel of claim 15, wherein a heavy object is set in the concave portion.
